(19) United States
(12) Patent Application Publication
(10) Pub. No.: US 2013/0109771 A1
(43) Pub. Date: May 2, 2013

(54) AZEOTROPE-LIKE COMPOSITIONS INCLUDING CIS-1-CHLORO-3,3,3-TRIFLUOROPROPENE

(71) Applicant: HONEYWELL INTERNATIONAL INC., MORRISTOWN, NJ (US)

(72) Inventors: RYAN HULSE, Getzville, NY (US); KANE D. COOK, Eggertsville, NY (US); RAJAT S. BASU, East Amherst, NY (US)

(73) Assignee: HONEYWELL INTERNATIONAL INC., MORRISTOWN, NJ (US)

(21) Appl. No.: 13/722,618

(22) Filed: Dec. 20, 2012

Related U.S. Application Data
(63) Continuation-in-part of application No. 13/298,452, filed on Nov. 17, 2011.
Application No. 13/298,452 is a continuation of application No. 12/605,609, filed on Oct. 26, 2009, now Pat. No. 8,163,196.
Application No. 12/605,609 is a continuation-in-part of application No. 12/259,694, filed on Oct. 28, 2008, now Pat. No. 7,935,268.
(60) Provisional application No. 61/578,974, filed on Dec. 22, 2011.
(60) Provisional application No. 61/109,007, filed on Oct. 28, 2008.

(51) Int. Cl. C09K 3/00; C09K 3/30; C09K 5/00

(52) U.S. Cl. CPC C09K 3/00; C09K 5/00; C09K 3/30
USPC 521/87; 252/67; 252/364; 516/12; 516/8; 521/98; 521/170; 521/155

(57) ABSTRACT

The present invention relates, in part, to azeotrope and azeotrope-like mixtures consisting essentially of consisting essentially of cis-1-chloro-3,3,3-trifluoropropene and a second component selected from the group water, hexane, HFC-365mfc, and perfluoro(2-methyl-3-pentanone).

### CROSS-REFERENCE TO RELATED APPLICATIONS

The present application claims priority to U.S. Provisional Application Ser. No. 61/578,974, filed Dec. 22, 2011, the contents of which are incorporated herein by reference in its entirety.

This application is a continuation-in-part of U.S. application Ser. No. 13/298,452, filed Nov. 17, 2011, which is a continuation of U.S. application Ser. No. 12/605,609, filed Oct. 26, 2009, which claims the priority benefit of U.S. Provisional Application No. 61/109,007, filed Oct. 28, 2008, and which is also a continuation-in-part of U.S. application Ser. No. 12/259,694, filed Oct. 28, 2008, the contents each of which are incorporated herein by reference in its entirety.

### FIELD OF THE INVENTION

The present invention relates generally to compositions comprising 1-chloro-3,3,3-trifluoropropene. More specifically, the present invention provides azeotrope-like compositions comprising cis-1-chloro-3,3,3-trifluoropropene and uses thereof.

### BACKGROUND OF THE INVENTION

Fluorocarbon based fluids, including chlorofluorocarbons (“CFCs”) or hydrochlorofluorocarbons (“HCFCs”), have properties that are desirable in industrial refrigerants, blowing agents, heat transfer media, solvents, gaseous dielectrics, and other applications. For these applications, the use of single component fluids or azeotrope-like mixtures, i.e., those which do not substantially fractionate on boiling and evaporation, are particularly desirable.

Unfortunately, suspected environmental problems, such as global warming and ozone depletion, have been attributed to the use of some of these fluids, thereby limiting their contemporary use. Hydrofluoroolefins (“HFOs”) have been proposed as possible replacements for such CFCs, HCFCs, and HFCs. However, the identification of new, environmentally-safe, non-fractionating mixtures comprising HFOs are complicated due to the fact that azeotrope formation is not readily predictable. Therefore, industry is continually seeking new HFO-based mixtures that are acceptable and environmentally safer substitutes for CFCs, HCFCs, and HFCs. This invention satisfies these needs among others.

### SUMMARY OF INVENTION

Applicants have discovered that azeotrope and/or azeotrope-like compositions are formed upon mixing cis-1-chloro-3,3,3-trifluoropropene (“cis-HFO-1233zd”) with a second component selected from the group consisting of water, hexane, HFC-365mfc (or 1,1,1,3,3-pentafluorobutane), and perfluoro(2-methyl-3-pentanone). Preferred azeotrope or azeotrope-like mixtures of the invention exhibit characteristics which make them particularly desirable for a number of applications, including as refrigerants, as blowing agents in the manufacture of insulating foams, and as solvents in a number of cleaning and other applications, including in aerosols and other sprayable compositions. In particular, applicants have recognized that these compositions tend to exhibit relatively low global warming potentials (“GWPs”), preferably less than about 1000, more preferably less than about 500, and even more preferably less than about 150.

Accordingly, one aspect of the present invention involves a composition comprising a binary azeotrope or azeotrope-like mixture consisting essentially of cis-1-chloro-3,3,3-trifluoropropene and a second component selected from the group consisting of water, hexane, HFC-365mfc, and perfluoro(2-methyl-3-pentanone). In certain preferred embodiments, the composition further comprises one or more of the following: co-blowing agent, co-solvent, active ingredient, and/or additive such as lubricants, stabilizers, metal passivators, corrosion inhibitors, and flammability suppressants. In certain preferred embodiments, nitromethane is included in the mixture as a stabilizer. In certain embodiments, nitromethane also contributes to the azeotrope or azeotrope-like properties of the composition.

Another aspect of the invention provides a blowing agent comprising at least about 15 wt. % of an azeotrope or azeotrope-like mixture as described herein, and, optionally, co-blowing agents, fillers, vapor pressure modifiers, flame suppressants, and/or stabilizers.

Another aspect of the invention provides a solvent for use in vapor degreasing, cold cleaning, wiping and similar solvent applications comprising an azeotrope or azeotrope-like mixture as described herein.

Another aspect of the invention provides a sprayable composition comprising an azeotrope or azeotrope-like mixture as described herein, an active ingredient, and, optionally, inert ingredients and/or solvents and aerosol propellants.

Yet another aspect of the invention provides closed cell foam comprising a polyurethane-, polyisocyanurate-, or phenolic-based cell wall and a cell gas disposed within at least a portion of the cell wall structure, wherein the cell gas comprises the azeotrope or azeotrope-like mixture as described herein.

According to another embodiment, provided is a polyol premix comprising the azeotrope or azeotrope-like mixture described herein.

According to another embodiment, provided is a foamable composition comprising the azeotrope or azeotrope-like mixture described herein.

According to another embodiment, provided is a method for producing thermoset foam comprising (a) adding a blowing agent comprising an azeotrope or azeotrope-like composition provided herein to a foamable mixture comprising a thermosetting resin; (b) reacting said foamable mixture to produce a thermoset foam; and (c) volatilizing said azeotrope or azeotrope-like composition during said reacting.

According to another embodiment, provided is a method for producing thermoplastic foam comprising (a) adding a blowing agent comprising an azeotrope or azeotrope-like composition provided herein to a foamable mixture comprising a thermoplastic resin; (b) reacting said foamable mixture to produce a thermoplastic foam; and (c) volatilizing said azeotrope or azeotrope-like composition during said reacting.

According to another embodiment, provided is a thermoplastic foam having a cell wall comprising a thermoplastic polymer and a cell gas comprising an azeotrope or azeotrope-like mixture as described herein. Preferably, the thermoplastic foam comprises a cell gas having an azeotrope or azeotrope-like mixture as described herein and having a cell wall constructed of a thermoplastic polymer selected from polystyrene, polyethylene, polypropylene, polyvinyl chloride, polytheyeneterephthalate or combinations thereof.

According to another embodiment, provided is a thermoset foam having a cell wall comprising a thermosetting polymer and a cell gas comprising an azeotrope or azeotrope-like mixture as described herein. Preferably, the thermoset foam comprises a cell gas having an azeotrope or azeotrope-like mixture as described herein and a cell wall comprising a thermoset polymer selected from polyurethane, polyisocyanurate, phenolic, epoxy, or combinations thereof.

According to another embodiment of the invention, provided is a refrigerant comprising an azeotrope or azeotrope-like mixture as described herein.

### BRIEF DESCRIPTION OF THE FIGURES

FIG. 1 provides a graphic illustration of cis-1233zd and water demonstrating azeotropic behavior, wherein the weight percent of water is provided on the X-axis.

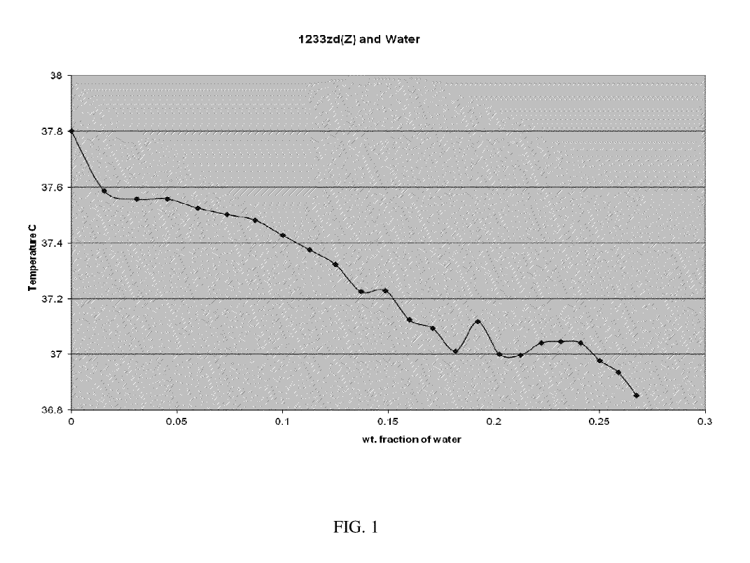

FIG. 2 provides a graphic illustration of cis-1233zd and n-hexane demonstrating azeotropic behavior, wherein the weight percent of n-hexane is provided on the X-axis.

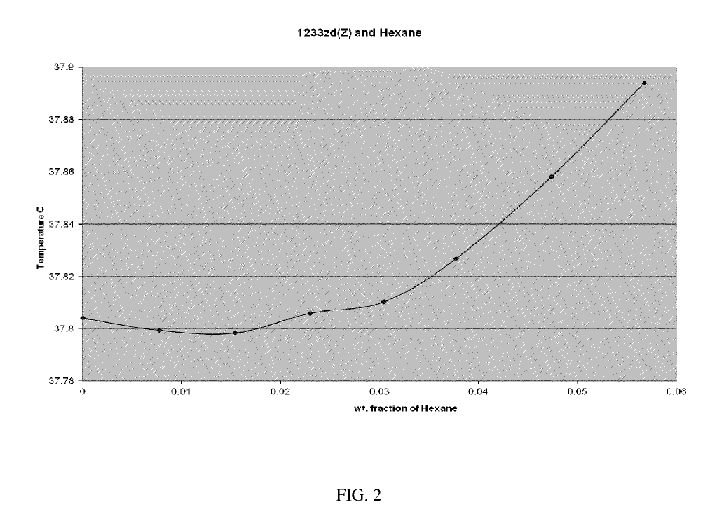

FIG. 3 provides a graphic illustration of cis-1233zd and HFC-365mfc demonstrating azeotropic behavior, wherein the weight percent of HFC-365mfc is provided on the X-axis.

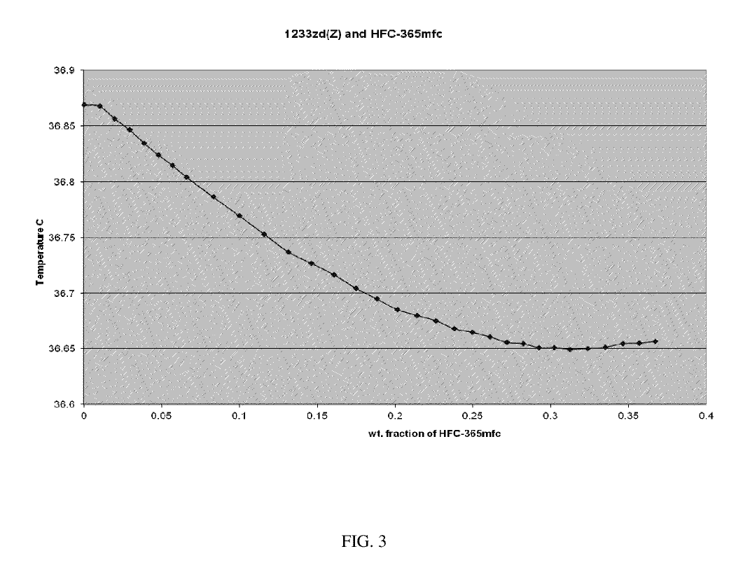

FIG. 4 provides a graphic illustration of cis-1233zd and perfluoro(2-methyl-3-pentanone) demonstrating azeotropic behavior, wherein the weight percent of perfluoro(2-methyl-3-pentanone) is provided on the X-axis.

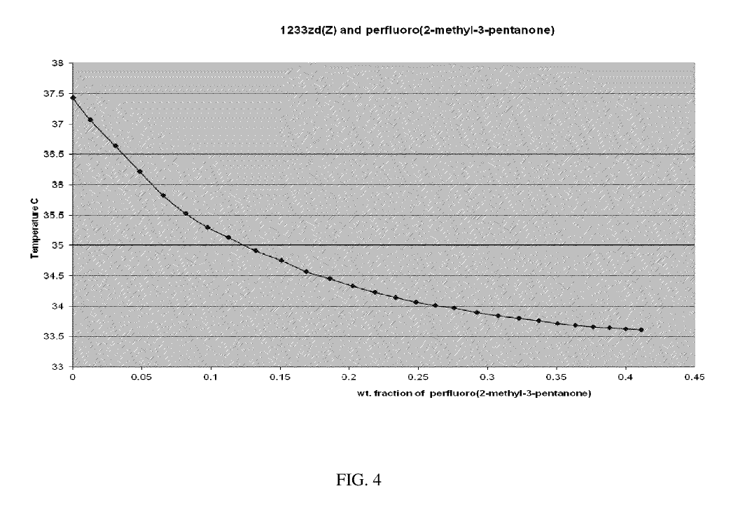

### DETAILED DESCRIPTION OF THE DRAWINGS

According to certain embodiments, the present invention provides azeotrope or azeotrope-like compositions comprising, and preferably consisting essentially of, cis-HFO-1233zd and at least one compound component selected from the group consisting of water, hexane, HFC-365mfc (or 1,1,1,3,3-pentafluorobutane), and perfluoro(2-methyl-3-pentanone).

As used herein, the term “azeotrope-like” relates to compositions that are strictly azeotropic or that generally behave like azeotropic mixtures. An azeotropic mixture is a system of two or more components in which the liquid composition and vapor composition are equal at the stated pressure and temperature. In practice, this means that the components of an azeotropic mixture are constant-boiling or essentially constant-boiling and generally cannot be thermodynamically separated during a phase change. The vapor composition formed by boiling or evaporation of an azeotropic mixture is identical, or substantially identical, to the original liquid composition. Thus, the concentration of components in the liquid and vapor phases of azeotrope-like compositions change only minimally, if at all, as the composition boils or otherwise evaporates. In contrast, boiling or evaporating non-azeotropic mixtures changes the component concentrations in the liquid phase to a significant degree.

As used herein, the term “consisting essentially of,” with respect to the components of an azeotrope or azeotrope-like composition, means the composition contains the indicated components in an azeotropic or azeotrope-like ratio, and may contain additional components provided that the additional components do not form new azeotrope or azeotrope-like systems. For example, azeotrope or azeotrope-like mixtures consisting essentially of two compounds are those that form binary azeotropes, which optionally may include one or more additional components, provided that the additional components do not render the mixture non-azeotropic and do not form an azeotrope with either or both of the compounds.

The term “effective amounts” as used herein refers to the amount of each component which, upon combination with the other component, results in the formation of an azeotrope or azeotrope-like composition of the present invention.

As used herein, the term cis-HFO-1233zd with respect to a component of an azeotrope or azeotrope-like mixture, means the amount cis-HFO-1233zd relative to all isomers of HFO-1233zd in the azeotrope or azeotrope-like compositions is at least about 95%, more preferably at least about 98%, even more preferably at least about 99%, even more preferably at least about 99.9%. In certain preferred embodiments, the cis-HFO-1233zd component in azeotrope or azeotrope-like compositions of the present invention is essentially pure cis-HFO-1233zd.

As used herein, the term “ambient pressure” with respect to boiling point data means the atmospheric pressure surrounding the relevant medium. In general, ambient pressure is 14.7 psia, but could vary +/−0.5 psi.

The azeotrope or azeotrope-like compositions of the present invention can be produced by combining effective amounts of cis-HFO-1233zd with one or more other components, preferably in fluid form. Any of a wide variety of methods known in the art for combining two or more components to form a composition can be adapted for use in the present methods. For example, cis-HFO-1233zd and any of the second components provided herein can be mixed, blended, or otherwise combined by hand and/or by machine, as part of a batch or continuous reaction and/or process, or via combinations of two or more such steps. In light of the disclosure herein, those of skill in the art will be readily able to prepare azeotrope or azeotrope-like compositions according to the present invention without undue experimentation.

Fluoropropenes, such as CF₃CCl═CH₂, can be produced by known methods such as catalytic vapor phase fluorination of various saturated and unsaturated halogen-containing C3 compounds, including the method described in U.S. Pat. Nos. 2,889,379; 4,798,818 and 4,465,786, each of which is incorporated herein by reference.

EP 974,571, also incorporated herein by reference, discloses the preparation of 1,1,1,3-chlorotrifluoropropene by contacting 1,1,1,3,3-pentafluoropropane (HFC-245fa) in the vapor phase with a chromium based catalyst at elevated temperature, or in the liquid phase with an alcoholic solution of KOH, NaOH, Ca(OH)2 or Mg(OH)2. The end product is approximately 90% by weight of the trans isomer and 10% by weight cis. Preferably, the cis isomers are substantially separated from the trans forms so that the resultant preferred form of 1-chloro-3,3,3-trifluoropropene is more enriched in the cis isomer. Because the cis isomer has a boiling point of about 40° C. in contrast with the trans isomer boiling point of about 20° C., the two can easily be separated by any number of distillation methods known in the art. However, another method is batch distillation. According to this method, a mixture of cis and trans 1-chloro-3,3,3-trifluoropropene is charged to the reboiler. The trans isomer is removed in the overhead leaving the cis isomer in the reboiler. The distillation can also be run in a continuous distillation where the trans isomer is removed in the overhead and the cis isomer is removed in the bottom. This distillation process can yield about 99.9+% pure trans-1-chloro-3,3,3-trifluoropropene and 99.9+% cis-1-chloro-3,3,3-trifluoropropene.

cis-HFO-1233zd/Water Azeotrope-Like Compositions

In one embodiment, the azeotrope or azeotrope-like composition includes effective amounts of cis-HFO-1233zd and water. More preferably, these binary azeotrope-like compositions consist essentially of about 50 to about 99.99 wt. % cis-HFO-1233zd and from about 0.01 to about 50 wt. % water, more preferably from about 70 to about 99.99 wt. % cis-HFO-1233zd and about 0.01 to about 30 wt. % water, and even more preferably from about 74 to about 99.99 wt. % cis-HFO-1233zd and from about 0.01 to about 26 wt. % water.

Preferably, the cis-HFO-1233zd/water compositions of the present invention have a normal boiling point of about 37° C.±1° C., at ambient pressure.

cis-HFO-1233zd/Hexane Azeotrope-Like Compositions

In a preferred embodiment, the azeotrope-like composition includes effective amounts of cis-HFO-1233zd and n-hexane. More preferably, these binary azeotrope-like compositions consist essentially of about 70 to about 99.99 wt. % cis-HFO-1233zd and from about 0.01 to about 30 wt. % n-hexane, more preferably from about 90 to about 99.99 wt. % cis-HFO-1233zd and about 0.01 to about 10 wt. % n-hexane, and even more preferably from about 94 to about 99.99 wt. % cis-HFO-1233zd and from about 0.01 to about 6 wt. % n-hexane.

In certain preferred embodiments, the composition includes a binary azeotrope of effective amounts of cis-1-chloro-3,3,3-trifluoropropene and n-hexane. More preferably, such effective amounts include where cis-1-chloro-3,3,3-trifluoropropene is provided in an amount between about 94 to about 99.99 weight percent and n-hexane is provided in an amount between about 0.01 to about 6 weight percent n-hexane; in further embodiments cis-1-chloro-3,3,3-trifluoropropene is provided in an amount between about 97 to about 99.99 weight percent and n-hexane is provided in an amount between about 0.01 to about 3 weight percent n-hexane; or cis-1-chloro-3,3,3-trifluoropropene is provided in an amount between about 98 to about 99.99 weight percent and n-hexane is provided in an amount between about 0.01 to about 2 weight percent n-hexane.

Preferably, the cis-HFO-1233zd/n-hexane azeotrope or azeotrope-like compositions of the present invention have a normal boiling point of about 37.8° C.±1° C., at ambient pressure.

cis-HFO-1233zd/HFC-365mfc Azeotrope-Like Compositions

In a preferred embodiment, the azeotrope-like composition comprises effective amounts of cis-HFO-1233zd and HFC-365mfc. More preferably, these binary azeotrope-like compositions consist essentially of about 60 to about 99.99 wt. % cis-HFO-1233zd and from about 0.01 to about 40 wt. % HFC-365mfc, more preferably from about 62 to about 99.99 wt. % cis-HFO-1233zd and about 0.01 to about 38 wt. % HFC-365mfc, and even more preferably from about 63 to about 99 wt. % cis-HFO-1233zd and from about 1 to about 37 wt. % HFC-365mfc.

In certain preferred embodiments, the composition includes a binary azeotrope of effective amounts of cis-1-chloro-3,3,3-trifluoropropene and HFC-365mfc. In certain aspects, such effective amounts include embodiments where cis-1-chloro-3,3,3-trifluoropropene is provided in an amount between about 63 to about 73 weight percent cis-1-chloro-3,3,3-trifluoropropene and about 27 to about 37 weight percent HFC-365mfc; or where cis-1-chloro-3,3,3-trifluoropropene is provided in an amount between about 67 to about 69 weight percent cis-1-chloro-3,3,3-trifluoropropene and about 31 to about 33 weight percent HFC-365mfc.

Preferably, the cis-HFO-1233zd/HFC-365mfc compositions of the present invention have a normal boiling point of about 36.7° C.±1° C., at ambient pressure.

cis-HFO-1233zd/Perfluoro(2-methyl-3-pentanone) Azeotrope-Like Compositions

In a preferred embodiment, the azeotrope-like composition comprises effective amounts of cis-HFO-1233zd and perfluoro(2-methyl-3-pentanone). More preferably, these binary azeotrope-like compositions consist essentially of about 50 to about 99.99 wt. % cis-HFO-1233zd and from about 0.01 to about 50 wt. % perfluoro(2-methyl-3-pentanone), more preferably from about 55 to about 99.99 wt. % cis-HFO-1233zd and about 0.01 to about 45 wt. % perfluoro(2-methyl-3-pentanone), and even more preferably from about 60 to about 88 wt. % cis-HFO-1233zd and from about 12 to about 40 wt. % perfluoro(2-methyl-3-pentanone).

Preferably, the cis-HFO-1233zd/perfluoro(2-methyl-3-pentanone) compositions of the present invention have a normal boiling point of about 33.5° C.±2° C., at ambient pressure.

The azeotrope or azeotrope-like compositions of the present invention may further include a variety of optional additives including, but not limited to, lubricants, stabilizers, metal passivators, corrosion inhibitors, flammability suppressants, and the like. Examples of suitable stabilizers include diene-based compounds, and/or phenol compounds, and/or epoxides selected from the group consisting of aromatic epoxides, alkyl epoxides, alkenyl epoxides, and combinations of two or more thereof. Preferably, these optional additives do not affect the basic azeotrope or azeotrope-like characteristic of the composition.

Blowing Agents

In another embodiment of the invention, provided are blowing agents comprising at least one azeotrope or azeotrope-like mixture described herein. Polymer foams are generally of two general classes: thermoplastic foams and thermoset foams.

Thermoplastic foams are produced generally via any method known in the art, including those described in Throne, Thermoplastic Foams, 1996, Sherwood Publishers, Hinkley, Ohio, or Klempner and Sendijarevic, Polymeric Foams and Foam Technology, 2^{nd} Edition 2004, Hander Gardner Publications. Inc, Cincinnati, Ohio. For example, extruded thermoplastic foams can be prepared by an extrusion process whereby a solution of blowing agent in molten polymer, formed in an extruder under pressure, is forced through an orifice onto a moving belt at ambient temperature or pressure or optionally at reduced pressure to aid in foam expansion. The blowing agent vaporizes and causes the polymer to expand. The polymer simultaneously expands and cools under conditions that give it enough strength to maintain dimensional stability at the time corresponding to maximum expansion. Polymers used for the production of extruded thermoplastic foams include, but are not limited to, polystyrene, polyethylene (HDPE, LDPE, and LLDPE), polypropylene, polyethylene terephthalate, ethylene vinyl acetate, and mixtures thereof. A number of additives are optionally added to the molten polymer solution to optimize foam processing and properties including, but not limited to, nucleating agents (e.g., talc), flame retardants, colorants, processing aids (e.g., waxes), cross linking agents, permeability modifiers, and the like. Additional processing steps such as irradiation to increase cross linking, lamination of a surface film to improve foam skin quality, trimming and planning to achieve foam dimension requirements, and other processes may also be included in the manufacturing process.

In general, the blowing agent may include the azeotrope or azeotrope-like compositions of the present invention in widely ranging amounts. It is generally preferred, however, that the blowing agent compositions comprise at least about 15% by weight of one or more of the present azeotrope or azeotrope-like compositions. In certain preferred embodiments, the blowing agent composition comprises at least about 50% by weight of one or more of the present azeotrope or azeotrope-like compositions, and in certain embodiments the blowing agent composition consists essentially of one or more of the present azeotrope or azeotrope-like compositions. In certain preferred embodiments, the blowing agent includes, in addition to the present azeotrope or azeotrope-like mixtures, one or more co-blowing agents, fillers, vapor pressure modifiers, flame suppressants, stabilizers, and like adjuvants.

In certain preferred embodiments, the blowing agent is characterized as a physical (i.e., volatile) blowing agent comprising the azeotrope or azeotrope-like mixture of the present invention. In general, the amount of blowing agent present in the blended mixture is dictated by the desired foam densities of the final foams products and by the pressure and solubility limits of the process. For example, the proportions of blowing agent in parts by weight can fall within the range of about 1 to about 45 parts, more preferably from about 4 to about 30 parts, of blowing agent per 100 parts by weight of polymer. The blowing agent may comprise additional components mixed with the azeotrope or azeotrope-like composition, including chlorofluorocarbons such as trichlorofluoromethane (CFC-11), dichlorodifluoromethane (CFC-12), hydrochlorofluorocarbons such as 1,1-dichloro-1-fluoroethane (HCFC-141b), 1-chloro-1,1-difluoroethane (HCFC-142b), chlorodifluoromethane (HCFC-22), hydrofluorocarbons such as 1,1,1,2-tetrafluoroethane (HFC-134a), 1,1-difluoroethane (HFC-152a), 1,1,1,3,3-pentafluoropropane (HFC-245fa), and 1,1,1,3,3-pentafluorobutane (HFC-365mfc), hydrocarbons such as propane, butane, isobutane, cyclopentane, carbon dioxide, chlorinated hydrocarbons alcohols, ethers, ketones and mixtures thereof.

In certain embodiments, the blowing agent is characterized as a chemical blowing agent. Chemical blowing agents are materials that, when exposed to temperature and pressure conditions in the extruder, decompose to liberate a gas, generally carbon dioxide, carbon monoxide, nitrogen, hydrogen, ammonia, nitrous oxide, of mixtures thereof. The amount of chemical blowing agent present is dependent on the desired final foam density. The proportions in parts by weight of the total chemical blowing agent blend can fall within the range of from less than 1 to about 15 parts, preferably from about 1 to about 10 parts, of blowing agent per 100 parts by weight of polymer.

In certain preferred embodiments, dispersing agents, cell stabilizers, surfactants and other additives may also be incorporated into the blowing agent compositions of the present invention. Surfactants are optional, but preferably are added to serve as cell stabilizers. Some representative materials are sold under the names of DC-193, B-8404, and L-5340 which are, generally, polysiloxane polyoxyalkylene block co-polymers such as those disclosed in U.S. Pat. Nos. 2,834,748, 2,917,480, and 2,846,458, each of which are incorporated herein by reference.

Other optional additives for the blowing agent mixture include flame retardants or suppressants such as tri(2-chloroethyl)phosphate, tri(2-chloropropyl)phosphate, tri(2,3-dibromopropyl)-phosphate, tri(1,3-dichloropropyl) phosphate, diammonium phosphate, various halogenated aromatic compounds, antimony oxide, aluminum trihydrate, polyvinyl chloride, and the like. With respect to thermoset foams, in general any thermoset polymer can be used, including but not limited to polyurethane, polyisocyanurate, phenolic, epoxy, and combinations thereof. In general these foams are produced by bringing together chemically reactive components in the presence of one or more blowing agents, including the azeotrope or azeotrope-like composition of this invention and optionally other additives, including but not limited to cell stabilizers, solubility enhancers, catalysts, flame retardants, auxiliary blowing agents, inert fillers, dyes, and the like.

With respect to the preparation of polyurethane or polyisocyanurate foams using the azeotrope or azeotrope-like compositions described in the invention, any of the methods well known in the art can be employed, see Saunders and Frisch, Volumes I and II Polyurethanes Chemistry and Technology (1962) John Wiley and Sons, New York, N.Y. In general, polyurethane or polyisocyanurate foams are prepared by combining an isocyanate, a polyol or mixture of polyols, a blowing agent or mixture of blowing agents, and other materials such as catalysts, surfactants, and optionally, flame retardants, colorants, or other additives.

It is convenient in many applications to provide the components for polyurethane or polyisocyanurate foams in preblended formulations. Most typically, the foam formulation is preblended into two components. The isocyanate and optionally certain surfactants and blowing agents comprise the first component, commonly referred to as the “A” component. The polyol or polyol mixture, surfactant, catalysts, blowing agents, flame retardant, and other isocyanate reactive components comprise the second component, commonly referred to as the “B” component. Accordingly, polyurethane or polyisocyanurate foams are readily prepared by bringing together the A and B side components either by hand mix for small preparations and, preferably, machine mix techniques to form blocks, slabs, laminates, pour-in-place panels and other items, spray applied foams, froths, and the like. Optionally, other ingredients such as fire retardants, colorants, auxiliary blowing agents, water, and even other polyols can be added as a third stream to the mix head or reaction site. Most conveniently, however, they are all incorporated into one B Component as described above.

Any organic polyisocyanate can be employed in polyurethane or polyisocyanurate foam synthesis inclusive of aliphatic and aromatic polyisocyanates. Preferred as a class are the aromatic polyisocyanates. Typical aliphatic polyisocyanates are alkylene diisocyanates such as tri, tetra, and hexamethylene diisocyanate, isophorene diisocyanate, 4,4′-methylenebis(cyclohexyl isocyanate), and the like; typical aromatic polyisocyanates include m-, and p-phenylene diisocyanate, polymethylene polyphenyl isocyanate, 2,4- and 2,6-toluenediisocyanate, dianisidine diisocyanate, bitoylene isocyanate, naphthylene 1,4-diisocyanate, bis(4-isocyanatophenyl)methene, bis(2-methyl-4-isocyanatophenyl)methane, and the like.

Preferred polyisocyanates are the polymethylene polyphenyl isocyanates, particularly the mixtures containing from about 30 to about 85 percent by weight of methylenebis(phenyl isocyanate) with the remainder of the mixture comprising the polymethylene polyphenyl polyisocyanates of functionality higher than 2.

Typical polyols used in the manufacture of polyurethane foams include, but are not limited to, aromatic amino-based polyether polyols such as those based on mixtures of 2,4- and 2,6-toluenediamine condensed with ethylene oxide and/or propylene oxide. These polyols find utility in pour-in-place molded foams. Another example is aromatic alkylamino-based polyether polyols such as those based on ethoxylated and/or propoxylated aminoethylated nonylphenol derivatives. These polyols generally find utility in spray applied polyurethane foams. Another example is sucrose-based polyols such as those based on sucrose derivatives and/or mixtures of sucrose and glycerine derivatives condensed with ethylene oxide and/or propylene oxide.

Examples of polyols used in polyurethane modified polyisocyanurate foams include, but are not limited to, aromatic polyester polyols such as those based on complex mixtures of phthalate-type or terephthalate-type esters formed from polyols such as ethylene glycol, diethylene glycol, or propylene glycol. These polyols are used in rigid laminated boardstock, can be blended with other types of polyols such as sucrose based polyols, and used in other polyurethane foam applications such as described above.

Catalysts used in the manufacture of polyurethane foams are typically tertiary amines including, but not limited to, N-alkylmorpholines, N-alkylalkanolamines, N,N-dialkylcyclohexylamines, and alkylamines where the alkyl groups are methyl, ethyl, propyl, butyl, and the like and isomeric forms thereof; and hetrocyclic amines. Typical, but not limiting examples are triethylenediamine, tetramethylethylenediamine, bis(2-dimethylaminoethyl)ether, triethylamine, tripropylamine, tributylamine, triamylamine, pyridine, quinoline, dimethylpiperazine, piperazine, N,N-dimethylcyclohexylamine, N-ethylmorpholine, 2-methylpiperazine, N,N-dimethylethanolamine, tetramethylpropanediamine, methyltriethylenediamine, and the like, and mixtures thereof.

Optionally, non-amine polyurethane catalysts are used. Typical of such catalysts are organometallic compounds of bismuth, lead, tin, titanium, antimony, uranium, cadmium, cobalt, thorium, aluminum, mercury, zinc, nickel, cerium, molybdenum, vanadium, copper, manganese, zirconium, and the like. Included as illustrative are bismuth nitrate, lead 2-ethylhexoate, lead benzoate, ferric chloride, antimony trichloride and antimony glycolate. A preferred organo-tin class includes the stannous salts of carboxylic acids such as stannous octoate, stannous 2-ethylhexoate, stannous laurate, and the like, as well as dialkyl tin salts of carboxylic acids such as dibutyl tin diacetate, dibutyl tin dilaurate, dioctyl tin diacetate, and the like.

In the preparation of polyisocyanurate foams, trimerization catalysts are used for the purpose of converting the blends in conjunction with excess A component to polyisocyanurate-polyurethane foams. The trimerization catalysts employed can be any catalyst known to one skilled in the art, including, but not limited to, glycine salts and tertiary amine trimerization catalysts and alkali metal carboxylic acid salts and mixtures of the various types of catalysts. Preferred species within the classes are potassium acetate, potassium octoate, and N-(2-hydroxy-5-nonylphenol)methyl-N-methylglycinate.

Dispersing agents, cell stabilizers, and surfactants can be incorporated into the present blends. Surfactants, which are, generally, polysiloxane polyoxyalkylene block co-polymers, such as those disclosed in U.S. Pat. Nos. 2,834,748, 2,917,480, and 2,846,458, which are incorporated herein by reference.

Other optional additives for the blends can include flame retardants such as tris(2-chloroethyl)phosphate, tris(2-chloropropyl)phosphate, tris(2,3-dibromopropyl)phosphate, tris(1,3-dichloropropyl)phosphate, diammonium phosphate, various halogenated aromatic compounds, antimony oxide, aluminum trihydrate, polyvinyl chloride, and the like. Other optional ingredients can include from 0 to about 3 percent water, which chemically reacts with the isocyanate to produce carbon dioxide. This carbon dioxide acts as an auxiliary blowing agent.

Also included in the mixture are blowing agents or blowing agent blends as disclosed in this invention. Generally speaking, the amount of blowing agent present in the blended mixture is dictated by the desired foam densities of the final polyurethane or polyisocyanurate foams product. The proportions in parts by weight of the total blowing agent blend can fall within the range of from 1 to about 45 parts of blowing agent per 100 parts of polyol, preferably from about 4 to about 30 parts.

The polyurethane foams produced can vary in density from about 0.5 pound per cubic foot to about 40 pounds per cubic foot, preferably from about 1.0 to 20.0 pounds per cubic foot, and most preferably from about 1.5 to 6.0 pounds per cubic foot. The density obtained is a function of how much of the blowing agent or blowing agent mixture disclosed in this invention is present in the A and/or B components, or alternatively added at the time the foam is prepared.

Foams and Foamable Compositions

Certain embodiments of the present invention involve a foam comprising a polyurethane-, polyisocyanurate-, or phenolic-based cell wall and a cell gas disposed within at least a portion of the cells, wherein the cell gas comprises the azeotrope-like mixture described herein. In certain embodiments, the foams are extruded thermoplastic foams. Preferred foams have a density ranging from about 0.5 pounds per cubic foot to about 60 pounds per cubic foot, preferably from about 1.0 to 20.0 pounds per cubic foot, and most preferably from about 1.5 to 6.0 pounds per cubic foot. The foam density is a function of how much of the blowing agent or blowing agent mixture (i.e., the azeotrope-like mixture and any auxiliary blowing agent, such as carbon dioxide, chemical blowing agent or other co-blowing agent) is present in the molten polymer. These foams are generally rigid but can be made in various grades of softness to suit the end use requirements. The foams can have a closed cell structure, an open cell structure or a mixture of open and closed cells, with closed cell structures being preferred. These foams are used in a variety of well known applications, including but not limited to thermal insulation, flotation, packaging, void filling, crafts and decorative, and shock absorption.

In other embodiments, the invention provides foamable compositions. The foamable compositions of the present invention generally include one or more components capable of forming foam, such as polyurethane, polyisocyanurate, and phenolic-based compositions, and a blowing agent comprising at least one azeotrope-like mixture described herein. In certain embodiments, the foamable composition comprises thermoplastic materials, particularly thermoplastic polymers and/or resins. Examples of thermoplastic foam components include polyolefins, such as polystyrene (PS), polyethylene (PE), polypropylene (PP) and polyethyleneterepthalate (PET), and foams formed therefrom, preferably low-density foams. In certain embodiments, the thermoplastic foamable composition is an extrudable composition.

In certain embodiments, provided is a method for producing such foams. It will be appreciated by those skilled in the art, especially in view of the disclosure contained herein, that the order and manner in which the blowing agent is formed and/or added to the foamable composition does not generally affect the operability of the present invention. For example, in the case of extrudable foams, it is possible to mix in advance the various components of the blowing agent. In certain embodiments, the components of the foamable composition are not mixed in advance of introduction to the extrusion equipment or are not added to the same location in the extrusion equipment. Thus, in certain embodiments it may be desired to introduce one or more components of the blowing agent at first location in the extruder, which is upstream of the place of addition of one or more other components of the blowing agent, with the expectation that the components will come together in the extruder and/or operate more effectively in this manner. In certain other embodiments, two or more components of the blowing agent are combined in advance and introduced together into the foamable composition, either directly or as part of premix which is then further added to other parts of the foamable composition.

Sprayable Compositions

In a preferred embodiment, the azeotrope-like compositions of this invention may be used as solvents in sprayable compositions, either alone or in combination with other known propellants. The solvent composition comprises, more preferably consists essentially of, and, even more preferably, consists of the azeotrope-like compositions of the invention. In certain embodiments, the sprayable composition is an aerosol.

In certain preferred embodiments, provided is a sprayable composition comprising a solvent as described above, an active ingredient, and optionally, other components such as inert ingredients, solvents, and the like.

Suitable active materials to be sprayed include, without limitation, cosmetic materials such as deodorants, perfumes, hair sprays, cleaning solvents, lubricants, insecticides as well as medicinal materials, such as anti-asthma medications. The term medicinal materials is used herein in its broadest sense to include any and all materials which are, or at least are believe to be, effective in connection with therapeutic, diagnostic, pain relief, and similar treatments, and as such would include for example drugs and biologically active substances.

Solvents and Cleaning Compositions

In another embodiment of the invention, the azeotrope or azeotrope-like compositions described herein can be used as a solvent in cleaning various soils such as mineral oil, rosin based fluxes, silicon oils, lubricants, etc., from various substrates by wiping, vapor degreasing, flushing, or other means. In certain preferred embodiments, the cleaning composition is an aerosol.

### EXAMPLES

The invention is further illustrated in the following example which is intended to be illustrative, but not limiting in any manner. For the relevant examples, an ebulliometer of the general type described by Swietolslowski in his book “Ebulliometric Measurements” (Reinhold, 1945) was used.

### Example 1

### cis-HFO-1233zd/Water Azeotrope-Like Compositions

An ebulliometer consisting of vacuum jacketed tube with a condenser on top which was further equipped with a Quartz Thermometer or a thermistor was used. About 10 cc of cis-HFO-1233zd was charged to the ebulliometer and then water was added in small, measured increments. As shown in Table 1, below, compositions comprising from about 73 to about 84 weight percent cis-HFO-1233zd had a change in boiling point of 0.4° C. or less. Thus the compositions exhibited azeotrope and/or azeotrope-like properties over at least this range.

TABLE 1
cis-HFO-1233zd/water compositions at ambient pressure

| Wt % of cis- | | |
|---|---|---|
| 1233zd | Wt % water | Temp, ° C. |
| 1 | 0 | 37.80 |
| 98.44 | 1.56 | 37.58 |
| 96.92 | 3.08 | 37.55 |
| 95.45 | 4.55 | 37.55 |
| 94.03 | 5.97 | 37.52 |
| 92.65 | 7.35 | 37.50 |
| 91.30 | 8.70 | 37.48 |
| 90.00 | 10.00 | 37.42 |
| 88.73 | 11.27 | 37.37 |
| 87.50 | 12.50 | 37.32 |
| 86.30 | 13.70 | 37.22 |
| 85.13 | 14.87 | 37.22 |
| 84.00 | 16.00 | 37.12 |
| 82.89 | 17.11 | 37.09 |
| 81.82 | 18.18 | 37.01 |
| 80.70 | 19.23 | 37.11 |
| 79.75 | 20.25 | 36.99 |
| 78.75 | 21.25 | 36.99 |
| 77.78 | 22.22 | 37.04 |
| 76.83 | 23.17 | 37.04 |
| 75.90 | 24.10 | 37.04 |
| 75.00 | 25.00 | 36.97 |
| 74.12 | 25.88 | 36.93 |
| 73.26 | 26.74 | 36.85 |

### Example 2

### cis-HFO-1233zd/Hexane Azeotrope-Like Compositions

An ebulliometer consisting of vacuum jacketed tube with a condenser on top which was further equipped with a Quartz Thermometer or a thermistor was used. About 10 cc of cis-HFO-1233zd was charged to the ebulliometer and then n-hexane was added in small, measured increments. As shown in Table 2, below, compositions comprising from about 99.99 to about 94.33 weight percent cis-HFO-1233zd had a change in boiling point of about 0.1° C. or less. Thus the compositions exhibited azeotrope and/or azeotrope-like properties over at least this range.

TABLE 2
cis-HFO-1233zd/Hexane Azeotrope-Like Compositions

| Wt % of cis- | | |
|---|---|---|
| 1233zd | Wt % n-hexane | Temp, ° C. |
| 1 | 0 | 37.80 |
| 99.22 | 0.78 | 37.79 |
| 98.45 | 1.55 | 37.79 |
| 97.70 | 2.30 | 37.80 |
| 96.96 | 3.04 | 37.81 |
| 96.22 | 3.78 | 37.82 |
| 95.27 | 4.73 | 37.85 |
| 94.33 | 5.67 | 37.89 |

### Example 3

### cis-HFO-1233zd/HFC-365mfc Azeotrope-Like Compositions

An ebulliometer consisting of vacuum jacketed tube with a condenser on top which was further equipped with a Quartz Thermometer or a thermistor was used. About 10 cc of cis-HFO-1233zd was charged to the ebulliometer and then HFC-365mfc was added in small, measured increments. As shown in Table 3, below, compositions comprising from about 63 to about 84 weight percent cis-HFO-1233zd had a change in boiling point of 0.5° C. or less. Thus the compositions exhibited azeotrope and/or azeotrope-like properties over at least this range.

TABLE 3
cis-HFO-1233zd/HFC-365mfc compositions at ambient pressure

| Wt % of cis- | Wt % HFC- | |
|---|---|---|
| 1233zd | 365mfc | Temp, ° C. |
| 100.00 | 0.00 | 36.86 |
| 99.00 | 1.00 | 36.86 |
| 98.02 | 1.98 | 36.85 |
| 97.07 | 2.93 | 36.84 |
| 96.12 | 3.88 | 36.83 |
| 95.20 | 4.80 | 36.82 |
| 94.30 | 5.70 | 36.81 |
| 93.41 | 6.59 | 36.80 |
| 91.68 | 8.32 | 36.78 |
| 90.02 | 9.98 | 36.76 |
| 88.41 | 11.59 | 36.75 |
| 86.87 | 13.13 | 36.73 |
| 85.37 | 14.63 | 36.72 |
| 83.93 | 16.07 | 36.71 |
| 82.53 | 17.47 | 36.70 |
| 81.18 | 18.82 | 36.69 |
| 79.87 | 20.13 | 36.68 |
| 78.61 | 21.39 | 36.67 |
| 77.38 | 22.62 | 36.67 |
| 76.19 | 23.81 | 36.66 |
| 75.04 | 24.96 | 36.66 |
| 73.92 | 26.08 | 36.66 |
| 72.84 | 27.16 | 36.65 |
| 71.78 | 28.22 | 36.65 |
| 70.76 | 29.24 | 36.65 |
| 69.76 | 30.24 | 36.65 |
| 68.80 | 31.20 | 36.64 |
| 67.62 | 32.38 | 36.64 |
| 66.49 | 33.51 | 36.65 |
| 65.40 | 34.60 | 36.65 |
| 64.33 | 35.67 | 36.65 |
| 63.31 | 36.69 | 36.65 |

### Example 4

### cis-HFO-1233zd/Perfluoro(2-methyl-3-pentanone) Azeotrope-Like Compositions

An ebulliometer consisting of vacuum jacketed tube with a condenser on top which was further equipped with a Quartz Thermometer or a thermistor was used. About 10 cc of cis-HFO-1233zd was charged to the ebulliometer and then perfluoro(2-methyl-3-pentanone) was added in small, measured increments. As shown in Table 4, below, compositions comprising from about 59 to about 65 weight percent cis-HFO-1233zd had a change in boiling point of 0.2° C. or less. Thus the compositions exhibited azeotrope and/or azeotrope-like properties over at least this range.

TABLE 4
cis-HFO-1233zd/perfluoro 2-methyl-3-pentanone
compositions at ambient pressure

| | Wt % | |
|---|---|---|
| | Perfluoro(2- | |
| Wt % of cis- | methyl-3- | |
| 1233zd | pentanone) | Temp, ° C. |
| 100 | 0.00 | 37.42 |
| 98.75 | 1.25 | 37.06 |
| 96.92 | 3.08 | 36.63 |
| 95.17 | 4.83 | 36.21 |
| 93.47 | 6.53 | 35.82 |
| 91.84 | 8.16 | 35.52 |
| 90.26 | 9.74 | 35.29 |
| 88.73 | 11.27 | 35.12 |
| 86.78 | 13.22 | 34.90 |
| 84.91 | 15.09 | 34.74 |
| 83.11 | 16.89 | 34.56 |
| 81.40 | 18.60 | 34.44 |
| 79.75 | 20.25 | 34.32 |
| 78.16 | 21.84 | 34.22 |
| 76.64 | 23.36 | 34.14 |
| 75.18 | 24.82 | 34.06 |
| 73.77 | 26.23 | 34.00 |
| 72.41 | 27.59 | 33.96 |
| 70.79 | 29.21 | 33.89 |
| 69.23 | 30.77 | 33.83 |
| 67.74 | 32.26 | 33.79 |
| 66.32 | 33.68 | 33.75 |
| 64.95 | 35.05 | 33.71 |
| 63.64 | 36.36 | 33.68 |
| 62.38 | 37.62 | 33.65 |
| 61.16 | 38.84 | 33.64 |
| 60.00 | 40.00 | 33.62 |
| 58.88 | 41.12 | 33.61 |

### Examples 5-8

For each of the following compositions, an azeotrope or azeotrope-like mixture is loaded into an aerosol can. An aerosol valve is crimped into place and HFC-134a is added through the valve to achieve a pressure in the can of about 20 PSIG. The mixture is then sprayed onto surface to demonstrate whether the azeotropic mixture is useful as an aerosol. Optionally, the aerosols have a different co-aerosol agent or no co-aerosol agent, and optionally have at least one active ingredient selected from the group consisting of deodorants, perfumes, hair sprays, cleaning solvents, lubricants, insecticides, and medicinal materials.

| Example | | |
|---|---|---|
| No. | Azeotrope-like Composition | Forms Aerosol |
| 5 | cis-1233zd + water | Yes |
| 6 | cis-1233zd + hexane | Yes |
| 7 | cis-1233zd + 365mfc | Yes |
| 8 | cis-1233zd + perfluoro(2-methyl-3- | Yes |
| | pentanone) | |

### Examples 9-12

For each of the following compositions, an azeotrope or azeotrope-like mixture is loaded into an aerosol can. An aerosol valve is crimped into place and HFC-134a is added through the valve to achieve a pressure in the can of about 20 PSIG. The mixture is then sprayed onto a metal coupon soiled with solder flux. The flux is removed and the coupon evaluated to see whether it is visibly clean and the azeotropic mixture is useful as a solvent. Optionally, the method of applying the azeotropic mixture as a cleaning agent is vapor degreasing or wiping instead of spraying. Optionally, the azeotropic mixture cleaning agent is applied neat. Optionally, the material to be cleaned is changed from solder flux to a mineral oil, silicon oil, or other lubricant.

| Example | | |
|---|---|---|
| No. | Azeotrope-like Composition | Visually Clean |
| 9 | cis-1233zd + water | Yes |
| 10 | cis-1233zd + hexane | Yes |
| 11 | cis-1233zd + 365mfc | Yes |
| 12 | cis-1233zd + perfluoro(2-methyl-3- | Yes |
| | pentanone) | |

### Examples 13-16

For each of the following compositions, an azeotrope or azeotrope-like mixture is prepared, silicone oil is mixed with the blend and the solvent was left to evaporate. If a thin coating of silicone oil is left behind in the coupon, this indicates that the solvent blends can be used for silicone oil deposition in various substrates.

| Example | | |
|---|---|---|
| No. | Azeotrope-like Composition | Oil Deposited |
| 13 | cis-1233zd + water | Yes |
| 14 | cis-1233zd + hexane | Yes |
| 15 | cis-1233zd + 365mfc | Yes |
| 16 | cis-1233zd + perfluoro(2-methyl-3- | Yes |
| | pentanone) | |

### Examples 17-20

For each of the following compositions, an azeotrope or azeotrope-like mixture is prepared and mineral oil is mixed with the blend. If the mineral oil is evenly disbursed throughout the blend, this indicates that the azeotrope or azeotrope-like composition can be used as a solvent.

| Example | | |
|---|---|---|
| No. | Azeotrope-like Composition | Good Solvency |
| 17 | cis-1233zd + water | Yes |
| 18 | cis-1233zd + hexane | Yes |
| 19 | cis-1233zd + 365mfc | Yes |
| 20 | cis-1233zd + perfluoro(2-methyl-3- | Yes |
| | pentanone) | |

### Examples 21-24

For each of the following compositions, an azeotrope or azeotrope-like mixture is prepared and is used as a blowing agent to prepare a closed-cell polyurethane foam and a closed-cell polyisocyanate foam. The cell-gas of the resulting foam is analyzed and it is determined if it contains at least a portion of the azeotropic mixture.

| | | Use as a | Polyurethane | Cell-gas of |
|---|---|---|---|---|
| | | Blowing | Foam and | foam contains |
| Example | | Agent | Polyisocyanate | Azeotrope-like |
| No. | Azeotrope-like Composition | Verified | Foam Formed | Mixture |
| 21 | cis-1233zd + water | Yes | Yes | Yes |
| 22 | cis-1233zd + hexane | Yes | Yes | Yes |
| 23 | cis-1233zd + 365mfc | Yes | Yes | Yes |
| 24 | cis-1233zd + perfluoro(2- | Yes | Yes | Yes |
| | methyl-3-pentanone) | | | |

### Examples 25-28

For each of the following compositions, an azeotrope or azeotrope-like mixture is prepared and several stainless steel coupons are soiled with mineral oil. Then these coupons are immersed in these solvent blends, and the coupons are observed to see if the azeotropic mixtures removed the oils in a short period of time.

| Example | | |
|---|---|---|
| No. | Azeotrope-like Composition | Visually Clean |
| 25 | cis-1233zd + water | Yes |
| 26 | cis-1233zd + hexane | Yes |
| 27 | cis-1233zd + 365mfc | Yes |
| 28 | cis-1233zd + perfluoro(2-methyl-3- | Yes |
| | pentanone) | |

### Examples 29-32

A solvent blend is prepared for azeotrope or azeotrope-like mixtures of each of the following compositions. Kester 1544 Rosin Soldering Flux is placed on stainless steel coupons and heated to approximately 300-400° F., which simulates contact with a wave soldier normally used to solder electronic components in the manufacture of printed circuit boards. The coupons are then dipped in the solvent mixture and removed after 15 seconds without rinsing. The coupons were then visually inspected to determine if they are clean.

| Example | | |
|---|---|---|
| No. | Azeotrope-like Composition | Visually Clean |
| 29 | cis-1233zd + water | Yes |
| 30 | cis-1233zd + hexane | Yes |
| 31 | cis-1233zd + 365mfc | Yes |
| 32 | cis-1233zd + perfluoro(2-methyl-3- | Yes |
| | pentanone) | |

### Example 33-36

Measured amount of commercial solder pastes are applied by a brush in printed circuit boards which are then reflowed as done in a commercial soldering operation. The circuit boards are dipped in a beaker using 100% the following azeotropic solvent blends to clean the boards. As indicated, each board looks visually clean after the operation.

| Example | | |
|---|---|---|
| No. | Azeotrope-like Composition | Visually Clean |
| 33 | cis-1233zd + water | Yes |
| 34 | cis-1233zd + hexane | Yes |
| 35 | cis-1233zd + 365mfc | Yes |
| 36 | cis-1233zd + perfluoro(2-methyl-3- | Yes |
| | pentanone) | |

### Examples 37-40

Pieces of fabrics are soiled by standard mineral oils, then 100% solutions of the azeotropic solvent blends below are used to clean the fabrics simulating a dry cleaning operation. Fabrics are visually clean after the operation. This indicates that these solvent blends can be used in dry cleaning application.

| Example | | |
|---|---|---|
| No. | Azeotrope-like Composition | Visually Clean |
| 37 | cis-1233zd + water | Yes |
| 38 | cis-1233zd + hexane | Yes |
| 39 | cis-1233zd + 365mfc | Yes |
| 40 | cis-1233zd + perfluoro(2-methyl-3- | Yes |
| | pentanone) | |

### Examples 41-44

A solvent blend is prepared for azeotrope or azeotrope-like mixtures of each of the following compositions. Mineral oil or other contaminate such as refrigerant oil, silicone oil, particulates or other residue is distributed on the interior of a line, heat exchanger, valve or other partial sealed component. The azeotrope or azeotrope like mixture is then combined with a propellant or pressurized in some manner such as with nitrogen in a container. The azeotrope or azeotrope like mixture is then allowed to flow through the interior of the contaminated components to remove the contaminants. Gravimetrically it is shown that there is a nearly complete removal of all contaminates after being flushed with azeotrope or azeotrope-like mixtures.

| Example | | Contaminant |
|---|---|---|
| No. | Azeotrope-like Composition | Removal |
| 41 | cis-1233zd + water | Yes |
| 42 | cis-1233zd + hexane | Yes |
| 43 | cis-1233zd + 365mfc | Yes |
| 44 | cis-1233zd + perfluoro(2-methyl-3- | Yes |
| | pentanone) | |

Having thus described a few particular embodiments of the invention, various alterations, modifications, and improvements will readily occur to those skilled in the art. Such alterations, modifications, and improvements, as are made obvious by this disclosure, are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A composition comprising a binary azeotrope or azeotrope-like mixture consisting essentially of cis-1-chloro-3,3,3-trifluoropropene and a second component selected from the group consisting of water and perfluoro(2-methyl-3-pentanone).

2. The composition of claim 1 wherein said azeotrope or azeotrope-like mixture consists essentially of about 50 to about 99.99 weight percent cis-1-chloro-3,3,3-trifluoropropene and about 0.01 to about 50 weight percent water.

3. The composition of claim 1 wherein said azeotrope or azeotrope-like mixture consists essentially of about 70 to about 99.99 weight percent cis-1-chloro-3,3,3-trifluoropropene and about 0.01 to about 30 weight percent water.

4. The composition of claim 1 wherein said azeotrope or azeotrope-like mixture consists essentially of about 74 to about 99.99 weight percent cis-1-chloro-3,3,3-trifluoropropene and about 0.01 to about 26 weight percent water.

5. The composition of claim 1 wherein said azeotrope or azeotrope-like mixture consists essentially of cis-1-chloro-3,3,3-trifluoropropene and water and has a boiling point of about 36.7° C.±1° C. at ambient pressure.

6. The composition of claim 1 wherein said azeotrope or azeotrope-like mixture consists essentially of about 50 to about 99.99 weight percent cis-1-chloro-3,3,3-trifluoropropene and about 0.01 to about 50 weight percent perfluoro(2-methyl-3-pentanone).

7. The composition of claim 1 wherein said azeotrope or azeotrope-like mixture consists essentially of about 55 to about 99.99 weight percent cis-1-chloro-3,3,3-trifluoropropene and about 0.01 to about 45 weight percent perfluoro(2-methyl-3-pentanone).

8. The composition of claim 1 wherein said azeotrope or azeotrope-like mixture consists essentially of about 60 to about 88 weight percent cis-1-chloro-3,3,3-trifluoropropene and about 12 to about 40 weight percent perfluoro(2-methyl-3-pentanone).

9. The composition of claim 1 wherein said azeotrope or azeotrope-like mixture consists essentially of cis-1-chloro-3,3,3-trifluoropropene and perfluoro(2-methyl-3-pentanone) and has a boiling point of about 33.5° C.±2° C. at ambient pressure.

10. The composition of claim 1 further comprising at least one adjuvant.

11. A heat transfer composition comprising the composition of claim 10, wherein said adjuvant is selected from the group consisting of a co-blowing agents, fillers, vapor pressure modifiers, flame suppressants, stabilizers, lubricants, and combinations thereof.

12. A heat transfer composition comprising at least about 50% by weight of the composition of claim 1.

13. A blowing agent comprising the composition of claim 1.

14. A blowing agent comprising at least about 5% by weight of the composition of claim 1.

15. A foamable composition comprising one or more components capable of forming foam and the composition of claim 1.

16. A foam formed from the foamable composition of claim 15.

17. A closed cell foam comprising the foam of claim 16.

18. A sprayable composition comprising a material to be sprayed and a propellant comprising the composition of claim 1.

19. The sprayable composition of claim 18 in the form of an aerosol.

20. The sprayable composition of claim 18 wherein said material to be sprayed is selected from the group consisting of cosmetics, cleaning solvent, lubricants and medicinal materials.

21. A solvent composition comprising the composition of claim 1.

22. A composition comprising a binary azeotrope consisting essentially of cis-1-chloro-3,3,3-trifluoropropene and a second component selected from the group consisting of n-hexane and HFC-365mfc.

23. The composition of claim 22 wherein said azeotrope consists essentially of cis-1-chloro-3,3,3-trifluoropropene and n-hexane.

24. The composition of claim 23 wherein cis-1-chloro-3,3,3-trifluoropropene is provided in an amount between about 97 to about 99.99 weight percent and n-hexane is provided in an amount between about 0.01 to about 3 weight percent n-hexane.

25. The composition of claim 23 wherein cis-1-chloro-3,3,3-trifluoropropene is provided in an amount between about 98 to about 99.99 weight percent and n-hexane is provided in an amount between about 0.01 to about 2 weight percent n-hexane.

26. The composition of claim 23 wherein said azeotrope has a boiling point of about 37.8° C.±1° C. at ambient pressure.

27. The composition of claim 22 wherein said azeotrope consists essentially of cis-1-chloro-3,3,3-trifluoropropene and HFC-365mfc.

28. The composition of claim 27 wherein cis-1-chloro-3,3,3-trifluoropropene is provided in an amount between about 63 to about 73 weight percent cis-1-chloro-3,3,3-trifluoropropene and about 27 to about 37 weight percent HFC-365mfc.

29. The composition of claim 27 wherein cis-1-chloro-3,3,3-trifluoropropene is provided in an amount between about 67 to about 69 weight percent cis-1-chloro-3,3,3-trifluoropropene and about 31 to about 33 weight percent HFC-365mfc.

30. The composition of claim 27 wherein said azeotrope-like mixture consists essentially of cis-1-chloro-3,3,3-trifluoropropene and HFC-365mfc and has a boiling point of about 36.7° C.±1° C. at ambient pressure.

31. The composition of claim 22 further comprising at least one adjuvant.

32. A heat transfer composition comprising the composition of claim 31, wherein said adjuvant is selected from the group consisting of a co-blowing agents, fillers, vapor pressure modifiers, flame suppressants, stabilizers, lubricants, and combinations thereof.

33. A heat transfer composition comprising at least about 50% by weight of the composition of claim 22.

34. A blowing agent comprising the composition of claim 22.

35. A blowing agent comprising at least about 5% by weight of the composition of claim 22.

36. A foamable composition comprising one or more components capable of forming foam and the composition of claim 22.

37. A foam formed from the foamable composition of claim 36.

38. A closed cell foam comprising the foam of claim 37.

39. A sprayable composition comprising a material to be sprayed and a propellant comprising the composition of claim 22.

40. The sprayable composition of claim 39 in the form of an aerosol.

41. The sprayable composition of claim 39 wherein said material to be sprayed is selected from the group consisting of cosmetics, cleaning solvent, lubricants and medicinal materials.

42. A solvent composition comprising the composition of claim 22.
